(19) United States
(12) Patent Application Publication
(10) Pub. No.: US 2026/0011835 A1
(43) Pub. Date: Jan. 8, 2026

(54) SECONDARY BATTERY

(71) Applicant: Samsung SDI Co., Ltd., Yongin-si, Gyeonggi-do (KR)

(72) Inventor: Jin Su DO, Yongin-si (KR)

(21) Appl. No.: 19/006,716

(22) Filed: Dec. 31, 2024

(30) Foreign Application Priority Data
Jul. 8, 2024 (KR) 10-2024-0089406

(51) Int. Cl. H01M 50/198; H01M 50/105; H01M 50/186; H01M 50/531; H01M 50/586

(52) U.S. Cl. CPC H01M 50/198; H01M 50/186; H01M 50/531; H01M 50/586; H01M 50/105

(57) ABSTRACT

A secondary battery includes: a case; and an electrode assembly accommodated in the case. The electrode assembly includes a first electrode, a second electrode, and a separator. The first electrode and the second electrode include electrode tabs. The electrode tabs of the first electrode and the second electrode are respectively connected to leads. An insulating layer is on one region of the leads, a sealing layer is on a sealing region of the case, and a conductive layer is arranged between the insulating layer and the sealing layer.

### CROSS-REFERENCE TO THE RELATED APPLICATION

The present application claims priority to and the benefit of Korean Patent Application No. 10-2024-0089406, filed on Jul. 8, 2024, in the Korean Intellectual Property Office, the entire disclosure of which is incorporated herein by reference.

### BACKGROUND

### 1. Field

Aspects of embodiments of the present disclosure relate to a secondary battery.

### 2. Description of the Related Art

Different from primary batteries, which are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly including (or composed of) a positive electrode and a negative electrode, a case accommodating the same, and electrode terminals connected to the electrode assembly.

The information disclosed in this section is provided for enhancement of understanding of the background of the present disclosure, and therefore, it may contain information that does not form the prior art.

### SUMMARY

Embodiments of the present disclosure provide a secondary battery having improved safety.

The secondary battery, according to an embodiment of the present disclosure, includes: a case; and an electrode assembly accommodated in the case and including a first electrode, a second electrode, and a separator. The first electrode and the second electrode include electrode tabs. The electrode tabs of the first electrode and the second electrode are respectively connected to leads, an insulating layer is on one region of the leads, a sealing layer is on a sealing region of the case, and a conductive layer is between the insulating layer and the sealing layer.

The first electrode may include a first electrode tab of the electrode tabs, the second electrode may include a second electrode tab of the electrode tabs, the first electrode tab may be connected to a first lead of the leads, the second electrode tab may be connected to a second lead of the leads, a first insulating layer is on the first lead, and a second insulating layer is on the second lead.

A melting temperature of the insulating layer and the sealing layer may be different from each other.

The melting temperature of the insulating layer may be lower than the melting temperature of the sealing layer.

A difference in melting temperature between the insulating layer and the sealing layer may be in a range of 30° C. to 50° C.

The melting temperature of the insulating layer may be in a range of 90° C. to 110° C., and the melting temperature of the sealing layer may be in a range of 130° C. to 140° C.

A resistance of the conductive layer may be in a range of 100 mΩ to 1Ω.

The case may have a first edge and a second edge. The leads may be on the first edge. The second edge may extend from an end of the first edge. The first edge and the second edge form a sealing region. The insulating layer, the sealing layer, and the conductive layer are arranged on the sealing region of the first edge, and the sealing layer is on the sealing region of the second edge.

The first edge may have a first region at where the insulating layer is arranged and a second region at where the insulating layer is not present, and the conductive layer may be on the first region.

When a thickness of the conductive layer at the first region is defined as A, and a sum of the thicknesses of the conductive layer at the first region and the insulating layer at the first region is defined as B, the thickness of the conductive layer of the first region may satisfy the following equation: B*0.2≤A≤B*0.5.

The conductive layer may be on at least one of upper and lower portions of the insulating layer.

The conductive layer may partially surround the insulating layer.

The secondary battery, according to another embodiment of the present disclosure, includes: a case; and an electrode assembly accommodated in the case and including a first electrode, a second electrode, and a separator. The first electrode and the second electrode respectively include electrode tabs. The electrode tab of the first electrode and the electrode tab of the second electrode are respectively connected to leads, an insulating layer is on one region of the lead, a sealing layer is on a sealing region of the case, a conductive layer is between the insulating layer and the sealing layer, and when an internal temperature of the electrode assembly increases to 100° C. or higher, the insulating layer melts before the sealing layer.

The first electrode may include a first electrode tab of the electrode tabs, the second electrode may include a second electrode tab of the electrode tabs, the first electrode tab is connected to a first lead, and the second electrode tab may be connected to a second lead. A first insulating layer is on the first lead, a second insulating layer is on the second lead, and when the first insulating layer and the second insulating layer melt, the first lead and the second lead may be electrically connected to each other via the conductive layer.

A difference in melting temperature between the insulating layer and the sealing layer may be in a range of 30° C. to 50° C.

A resistance of the conductive layer may be in a range of 100 mΩ to 1Ω, and, a resistance of the conductive layer may vary depending on a current of the secondary battery.

The resistance of the conductive layer may be inversely proportional to the current of the secondary battery.

### BRIEF DESCRIPTION OF THE DRAWINGS

The accompanying drawings, which are incorporated in this specification, illustrate embodiments of the present disclosure and further illustrate aspects, features, and technical ideas of the present disclosure in conjunction with the detailed description that follows, but the present disclosure is not to be construed as limited to what is shown in the drawings. In the drawings:

FIG. 1 is a perspective view of a secondary battery according to an embodiment.

FIGS. 2A and 2B are top views of lead tabs of the secondary battery according to an embodiment.

FIG. 3 is a top view of the secondary battery shown in FIG. 1 according to an embodiment.

FIG. 4 is a cross-sectional view taken along the line A-A′ in FIG. 3.

FIG. 5 is a cross-sectional view taken along the line B-B′ in FIG. 3.

FIG. 6 is a cross-sectional view taken along the line C-C′ in FIG. 3.

FIGS. 7 to 9 are views illustrating a short circuit of the lead tab due to melting of a conductive layer of the secondary battery according to an embodiment.

FIGS. 10 to 12 are cross-sectional views taken along the line A-A′ in FIG. 3 according to other embodiments.

FIGS. 13 and 14 are perspective views showing a battery pack including battery modules according to some embodiments.

FIGS. 15 and 16 are a perspective view and a side view, respectively, showing a vehicle including battery packs according to some embodiments.

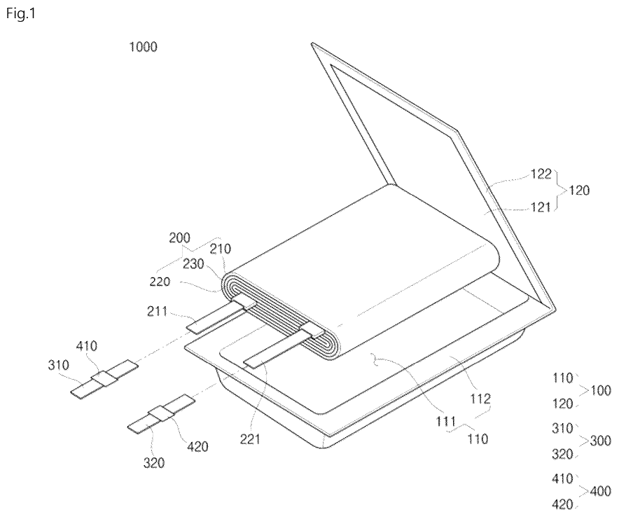

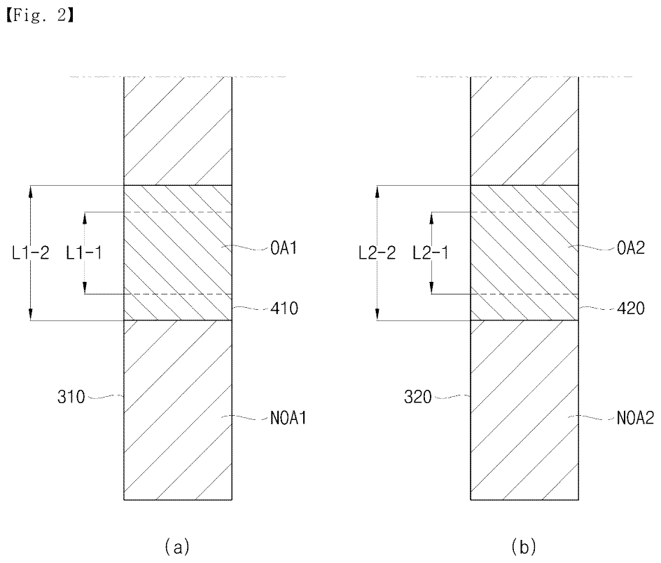

### DETAILED DESCRIPTION

Hereinafter, embodiments of the present disclosure will be described, in detail, with reference to the accompanying drawings. The terms or words used in the present specification and claims are not to be limitedly interpreted according to their general or dictionary meanings but should be interpreted as having meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of about 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Hereinafter, a secondary battery according to embodiments of the present disclosure will be described with reference to the drawings. The secondary battery may be classified as a cylindrical shape, a prismatic shape, a pouch shape, or a coin shape depending on the shape. The secondary battery described below may be applied to a pouch-type secondary battery, but this is merely one example.

The secondary battery 1000 according to an embodiment may include a case 100 and an electrode assembly 200.

The case 100 may include an accommodation part 110 and a cap part 120. The accommodation part 110 and the cap part 120 may be connected to each other. The case 100 may have a pouch shape.

The accommodation part 110 may have a concave part 111 and a first sealing region 112. The accommodation part 110 may include (or may form) an accommodation space. For example, the accommodation part 110 may have an internal bottom surface and an inner side surface formed by the concave part 111. The accommodation space may be formed by the bottom surface and the inner side surface.

The first sealing region 112 may be disposed at the edge of (e.g., along a periphery of) the accommodation part 110. A sealing layer may be disposed on the first sealing region 112.

The cap part 120 may have a cover part 121 and a second sealing region 122.

The cover part 121 may cover the accommodation part 110. For example, the cover part 121 may cover the electrode assembly 200 accommodated in the accommodation part 110.

The second sealing region 122 may be disposed at the edge of (e.g., around the periphery of) the cap part 120. The sealing layer may be disposed on the second sealing region 122. The first sealing region 112 and the second sealing region 122 may overlap. For example, when the accommodation part 110 is covered by the cap part 120, the first sealing region 112 and the second sealing region 122 may face each other.

The electrode assembly 200 may be accommodated in the case 100. For example, the electrode assembly 200 may be accommodated inside the accommodation space of the case. In the drawing, an embodiment in which one electrode assembly is accommodated in the case is illustrated. However, the present disclosure is not limited thereto. Two or more electrode assemblies may be accommodated in the case.

The electrode assembly 200 may include a first electrode 210, a second electrode 220, and a separator 230. The electrode assembly 200 may be formed by winding or laminating the first electrode 210, the second electrode 220, and the separator 230. When the electrode assembly 200 is a winding type, the winding axis may be parallel to the longitudinal direction of the case 100. In another embodiment, the electrode assembly may be a Z-stack electrode assembly in which the first electrode 210 and the second electrode 220 are inserted on both sides of the separator 230 bent (or folded) into a Z-stack.

The first electrode 210 may include a first electrode current collector and a first electrode active material layer. The first electrode current collector may include a metal foil, such as aluminum or an aluminum alloy. The first electrode active material layer may include a transition metal oxide. For example, the first electrode 210 may be a positive electrode.

The first electrode 210 may include a first electrode tab 211. The first electrode active material layer is not disposed on the first electrode tab 211. The first electrode tab 211 may be welded to the first electrode current collector. In another embodiment, the first electrode tab 211 may be formed integrally with the first electrode current collector. For example, the first electrode current collector may include a first uncoated portion on which the first electrode active material layer is not disposed. The first uncoated portion may be the first electrode tab 211.

The second electrode 220 may include a second electrode current collector and a second electrode active material layer. The second electrode current collector may include a metal foil, such as copper, a copper alloy, nickel, or a nickel alloy. The second electrode active material layer may include graphite or carbon. For example, the second electrode 220 may be a negative electrode.

The second electrode 220 may include a second electrode tab 221. The second electrode active material layer is not disposed on the second electrode tab 221. The second electrode tab 221 may be welded to the second electrode current collector. In another embodiment, the second electrode tab 221 may be formed integrally with the second electrode current collector. For example, the second electrode current collector may include a second uncoated portion on which the second electrode active material layer is not disposed. The second uncoated portion may be the second electrode tab 221.

The first electrode tab 211 and the second electrode tab 221 may each be connected to a lead. For example, the first electrode tab 211 may be connected to the first lead 310. The first electrode tab 211 may be connected to the first external terminal by the first lead 310. The second electrode tab 221 may be connected to the second lead 320. The second electrode tab 221 may be connected to the second external terminal by the second lead 320.

The first lead 310 may have a first overlapping area OA1 and a first non-overlapping area NOA1. The first overlapping area OA1 may have a 1-1 length L1-1. The first overlapping area OA1 may overlap the case 100. For example, the first overlapping area OA1 may overlap the first sealing region 112 and the second sealing region 122. The first non-overlapping area NOA1 does not overlap the first sealing region 112 and the second sealing region 122.

A first insulating layer 410 may be disposed on the first lead 310. For example, the first insulating layer 410 may be disposed on the first overlapping area OA1. The first insulating layer 410 may surround (e.g., may extend around) the first lead 310. For example, the first insulating layer 410 may be disposed on the upper surface, lower surface, and side surface of the first lead at the first overlapping area OA1.

The first insulating layer 410 may have a 1-2 length L1-2. The 1-2 length L1-2 may be longer than the 1-1 length L1-1. That is, the first insulating layer 410 may also be disposed on the first overlapping area OA1 and a portion of the first non-overlapping area NOA1. Accordingly, the first insulating layer 410 may be disposed to cover the entire first overlapping area OA1.

Therefore, the first lead 310 may be insulated from the case 100 by the first insulating layer 410. The first lead 310 and the case 100, which include different materials, may be easily coupled by the first insulating layer 410. For example, the first insulating layer 410 may be a buffer layer or an adhesive layer.

The second lead 320 may have a second overlapping area OA2 and a second non-overlapping area NOA2. The second overlapping area OA2 may have a 2-1 length L2-1. The second overlapping area OA2 may overlap with the case 100. For example, the second overlapping area OA2 may overlap with the first sealing region 112 and the second sealing region 122. The second non-overlapping area NOA2 does not overlap with the first sealing region 112 and the second sealing region 122.

A second insulating layer 420 may be disposed on the second lead 320. For example, the second insulating layer 420 may be disposed on the second overlapping area OA2. The second insulating layer 420 may surround (e.g., may extend around) the second lead 320. For example, the second insulating layer 420 may be disposed on the upper surface, lower surface, and side surface of the second lead on the second overlapping area OA2.

The second insulating layer 420 may have a 2-2 length L2-2. The 2-2 length L2-2 may be longer than the 2-1 length L2-1. For example, the second insulating layer 420 may be disposed on the second overlapping area OA2 and a portion of the second non-overlapping area NOA2. Accordingly, the second insulating layer 420 may be disposed to cover the entire second overlapping area OA2.

Therefore, the second lead 320 may be insulated from the case 100 by the second insulating layer 420. And, the second lead 320 and the case 100, which include different materials, may be easily coupled by the second insulating layer 420. For example, the second insulating layer 420 may be a buffer layer or an adhesive layer.

The internal temperature of the electrode assembly may increase due to overcharge or malfunction. If the secondary battery is exposed to a high-temperature environment for a long time, gas may be generated inside the electrode assembly. If the secondary battery is exposed to a high-temperature environment for a long time, the sealing layer may melt. A safety vent may form due to the melting of the sealing layer, and the gas may be discharged to the outside through the vent.

However, if the melting speed of the sealing layer is insufficient, the internal pressure of the electrode assembly may increase due to the gas. In such a case, before the safety vent is formed, a fire may occur in the secondary battery due to an increase in internal pressure.

According to embodiments of the present disclosure, an additional layer is disposed between the insulating layer and the sealing layer to ensure formation of a safety event before a fire occurs.

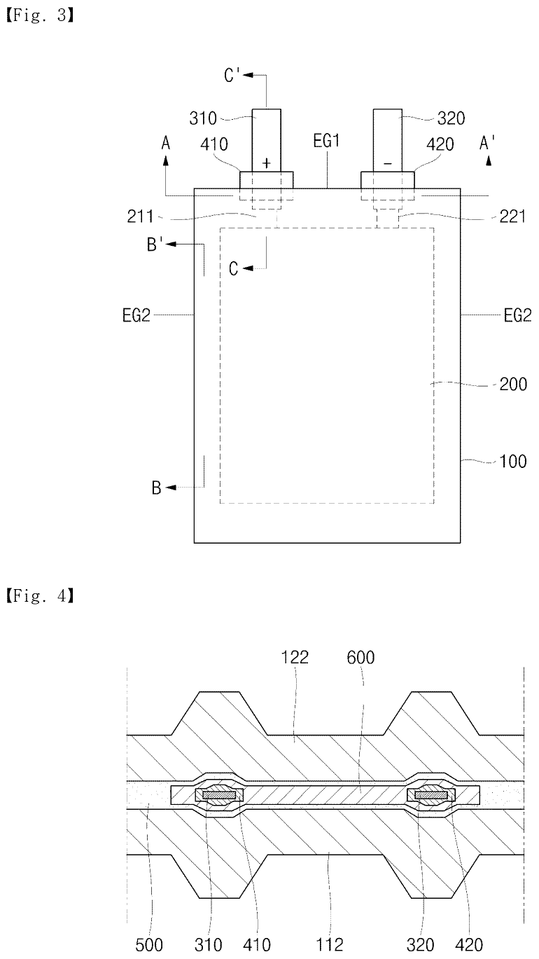

Referring to FIGS. 3 to 6, the case 100 may accommodate and seal the electrode assembly 200. For example, the accommodation part 110 and the cap part 120 may be coupled and sealed by the sealing layer 500. The sealing layer 500 may be disposed between the first sealing region 112 and the second sealing region 122. Accordingly, the first sealing region 112 and the second sealing region 122 may be bonded by the sealing layer 500.

The sealing layer 500 may be disposed along the edge of the case 100. For example, the case 100 may have a first edge EG1 and a second edge EG2. The first edge EG1 may be a region at where the electrode tab and the lead are disposed. For example, the first edge EG1 may be a terminal region. The second edge EG2 may be a region at where the electrode tab and the lead are not disposed. The second edge EG2 may be connected to (e.g., may extend from) one end of the first edge EG1.

The first sealing region 112 and the second sealing region 122 may be disposed on the first edge EG1 and the second edge EG2. The sealing layer 500 may be disposed on both the first edge EG1 and the second edge EG2.

The sealing layer 500 may include a resin material. For example, the sealing layer 500 may include a heat-melting material. For example, the sealing layer 500 may include a material having a melting temperature within a reference range (e.g., a set or predetermined range). For example, the melting temperature of the sealing layer 500 may be in a range of about 130° C. to about 140° C. For example, the sealing layer 500 may include polypropylene. However, the present disclosure is not limited thereto, and the sealing layer 500 may include various resins having a melting temperature within the range.

A conductive layer 600 may be disposed between the leads 310 and 320 and the sealing layer 500.

The conductive layer 600 may be disposed on at least one edge of the case 100. For example, the conductive layer 600 may be disposed on the first edge EG1. The conductive layer 600 may be disposed along the entire region or at a portion of the first edge EG1.

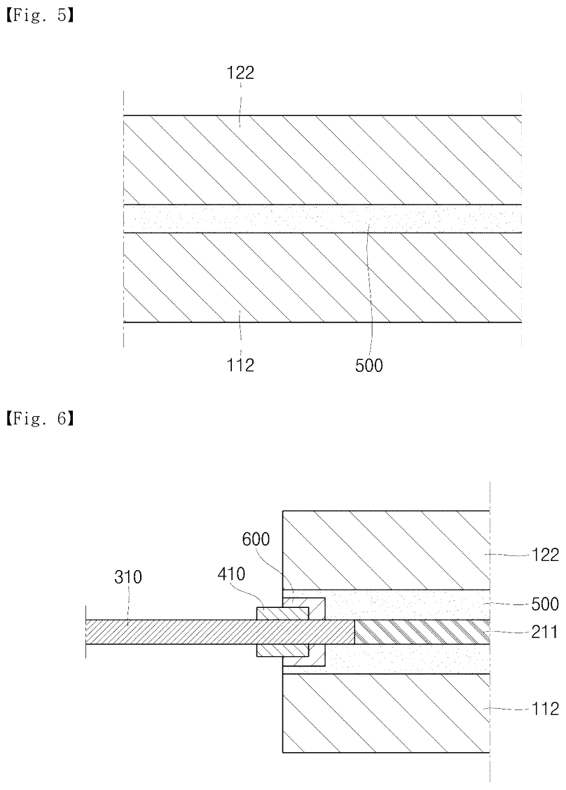

For example, referring to FIGS. 4 and 5, the conductive layer 600 may be disposed only on the first edge EG1, and may not be disposed on the second edge EG2.

Therefore, the insulating layers 410 and 420, the sealing layer 500, and the conductive layer 600 may be disposed on the first edge EG1 while only the sealing layer 500 may be disposed on the second edge EG2.

The conductive layer 600 may be disposed between the insulating layers 410 and 420 and the sealing layer 500. The conductive layer 600 may be disposed between the sealing layers 500. For example, the first edge EG1 may have a first region at where the insulating layers 410 and 420 are disposed and a second region at where the insulating layers 410 and 420 are not disposed. The conductive layer 600 may be disposed between the insulating layers 410 and 420 and the sealing layer 500 in the first region. The conductive layer 600 may be disposed between the sealing layers 500 in the second region.

The conductive layer 600 has conductivity (e.g., is electrically conductive). For example, the conductive layer 600 may include a metal or a metal alloy. For example, the conductive layer 600 may include nickel, chromium, or an alloy thereof.

The leads 310 and 320 are insulated by the insulating layers 410 and 420. Accordingly, when the secondary battery 1000 operates normally, the first lead 310 and the second lead 320 may be insulated by the insulating layers 410 and 420.

The first insulating layer 410 and the second insulating layer 420 may include the same or similar materials. The first insulating layer 410 and the second insulating layer 420 may include materials having a reference (e.g., a set or predetermined) melting temperature. For example, the melting temperatures of the first insulating layer 410 and the second insulating layer 420 may be different from the melting temperature of the sealing layer 500. For example, the melting temperatures of the first insulating layer 410 and the second insulating layer 420 may be lower than the melting temperature of the sealing layer 500.

For example, the melting temperature difference between the first insulating layer 410 and the second insulating layer 420 may be in a range of about 30° C. to about 50° C., in a range of about 35° C. to about 45° C., or in a range of about 38° C. to about 42° C. When the melting temperature difference between the first insulating layer 410 and the second insulating layer 420 is less than about 30° C., the temperature at which the secondary battery self-discharges increases. Accordingly, a fire in the secondary battery may occur before the secondary battery self-discharges. When the melting temperature difference between the first insulating layer 410 and the second insulating layer 420 exceeds about 50° C., the conductive layer may melt when the secondary battery is operating normally. Accordingly, the secondary battery may self-discharge when the secondary battery is operating normally.

For example, the melting temperatures of the first insulating layer 410 and the second insulating layer 420 may be in a range of about 90° C. to about 110° C. For example, the first insulating layer 410 and the second insulating layer 420 may include at least one of polyethylene (LDPE), polystyrene (PS), and ethylene-vinyl acetate copolymer (EVA).

Therefore, when the internal temperature of the secondary battery increases due to, for example, overcharging or malfunction of the electrode assembly, the insulating layers 410 and 420 are melted first. Accordingly, the first lead 310 and the second lead 320 may contact the conductive layer 600.

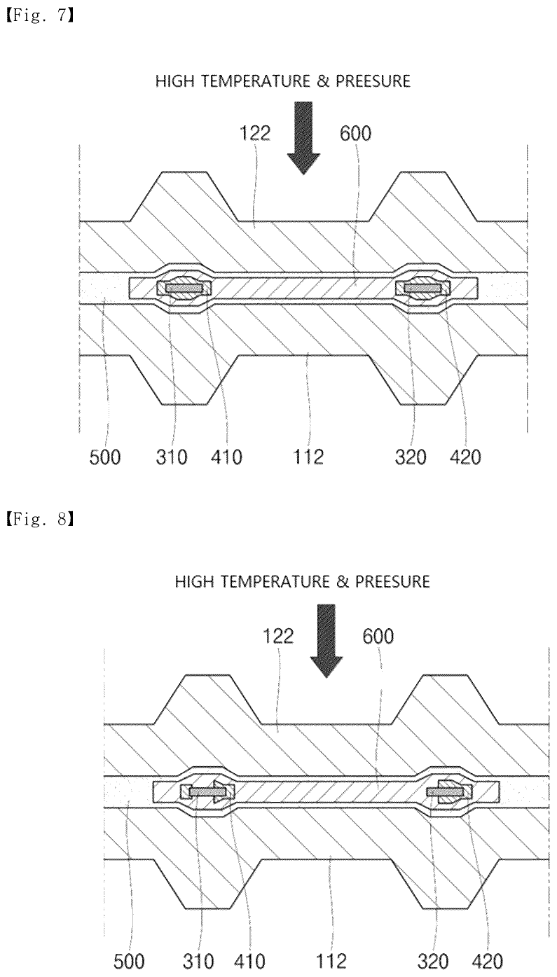

For example, referring to FIG. 7, the internal temperature of the secondary battery may increase due to, for example, overcharging or malfunction of the electrode assembly. Accordingly, the secondary battery may be exposed to a high-temperature environment for a long time. Accordingly, high-temperature gas may be generated inside the secondary battery. Accordingly, the inside of the secondary battery may become a high-temperature and high-pressure environment.

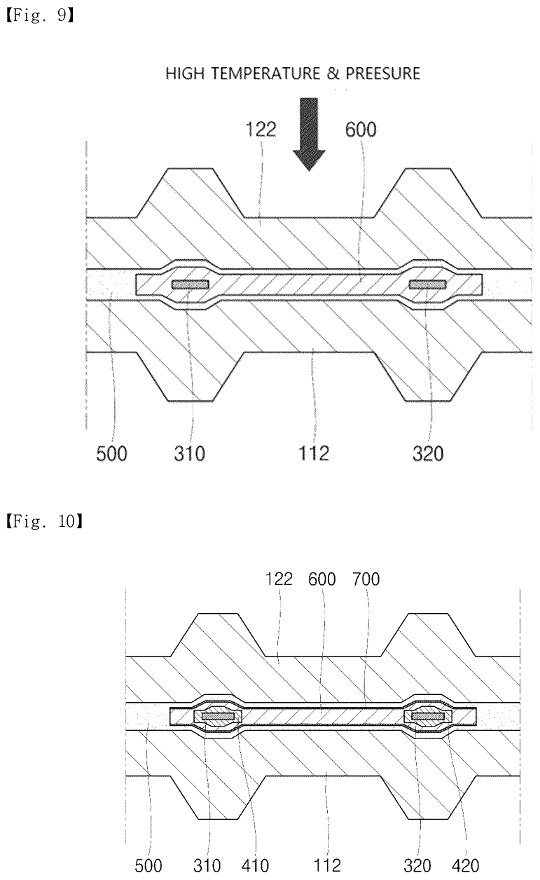

Referring to FIGS. 8 and 9, the insulating layers 410 and 420 may melt. The melting temperature of the insulating layers 410 and 420 is lower than the melting temperature of the sealing layer 500. Accordingly, the insulating layers 410 and 410 may melt before the sealing layer 500. For example, when the temperature inside the secondary battery (or the electrode assembly) increases to about 100° C. or higher, the insulating layers 410 and 420 may melt first (e.g., may melt before the sealing layer 500). Subsequently, the sealing layer 500 may melt.

Accordingly, the first lead 310 and the second lead 320 may make contact with the conductive layer 600. Therefore, the first lead 310 and the second lead 320 may be electrically connected and shorted. Accordingly, the secondary battery self-discharges, and the SOC (State Of Charge) of the secondary battery decreases.

The secondary battery may be vulnerable to high temperatures because the positive structure (e.g., the positive electrode) is unstable when the secondary battery is at a high charge state (e.g., SOC of about 100%). When the secondary battery is exposed to high temperatures in a fully charged state, gas may be generated inside the secondary battery. Rapid thermal runaway may occur as the positive structure collapses. Accordingly, a fire may occur in the secondary battery.

However, the secondary battery according to embodiments of the present disclosure may self-discharge when the secondary battery is exposed to a high temperature. Accordingly, the collapse of the positive structure may be prevented, thereby preventing thermal runaway. Accordingly, a fire of the secondary battery may be prevented. Accordingly, the secondary battery according to embodiments of the present disclosure exhibits improved stability.

The conductive layer 600 may have a reference (e.g., a set or predetermined) resistance. For example, the conductive layer 600 may have a resistance in a range of about 100 mΩ to about 1Ω, in a range of about 300 mΩ to about 800 mΩ, or in a range of about 500 mΩ to about 700 mΩ.

The resistance of the conductive layer 600 may vary depending on the current of the secondary battery. The resistance of the conductive layer 600 may vary depending on the composition of the material constituting the conductive layer.

The resistance of the conductive layer 600 may be inversely proportional to the current of the secondary battery. For example, when the current of the secondary battery is relatively high, the resistance of the conductive layer 600 may decrease. Accordingly, when the state of charge of the secondary battery is high, the discharge speed of the secondary battery may increase. Accordingly, thermal runaway of the secondary battery may be prevented, thereby preventing a fire.

The conductive layer 600 may have a reference (e.g., a set or predetermined) thickness. The conductive layer 600 may be disposed on the first region and the second region. The thickness of the conductive layer 600 at the first region and the thickness of the conductive layer 600 at the second region may be the same or different from each other.

The conductive layer 600 at the first region may have a thickness within a reference (e.g., a set or predetermined) range. For example, when the thickness of the conductive layer 600 at the first region is defined as A, and the sum of the thickness of the conductive layer 600 at the first region and the thickness of the insulating layers 410 and 420 at the first region is defined as B, the thickness of the conductive layer of the first region may be as follows:

$$B * 0.2 \leq A \leq B * 0.5$$

If the thickness of the conductive layer 600 at the first region is less than about B*0.2, the discharge speed of the secondary battery may decrease. Accordingly, a fire may occur in the secondary battery due to thermal runaway. If the thickness of the conductive layer 600 at the first region exceeds about B*0.5, the overall thickness of the secondary battery may increase due to the thickness of the conductive layer 600.

FIGS. 10 to 12 are cross-sectional views taken along the line A-A′ in FIG. 3 according to other embodiments.

Referring to FIG. 10, the secondary battery, according to an embodiment, may further include a buffer layer 700.

The buffer layer 700 may be disposed on the conductive layer 600. For example, the buffer layer 700 may be disposed between the sealing layer 500 and the conductive layer 600.

The buffer layer 700 may include a resin material. The buffer layer 700 may include the same or different material as the sealing layer 500 or the insulating layers 410 and 420.

The sealing layer 500 includes a resin, and the conductive layer 600 may include a metal. Therefore, the adhesive strength between the sealing layer 500 and the conductive layer 600 may be reduced. Accordingly, a gap may be formed between the sealing layer 500 and the conductive layer 600. As a result, impurities may penetrate into the interior of the secondary battery through the gap.

Therefore, after the buffer layer 700 is disposed on the conductive layer 600, when the sealing layer 500 is adhered, the sealing layer 500 is adhered to the buffer layer 700. Because both the sealing layer 500 and the buffer layer 700 include a resin material, the adhesive properties may be improved. Accordingly, the reliability of the secondary battery may be improved and a gap may not be formed.

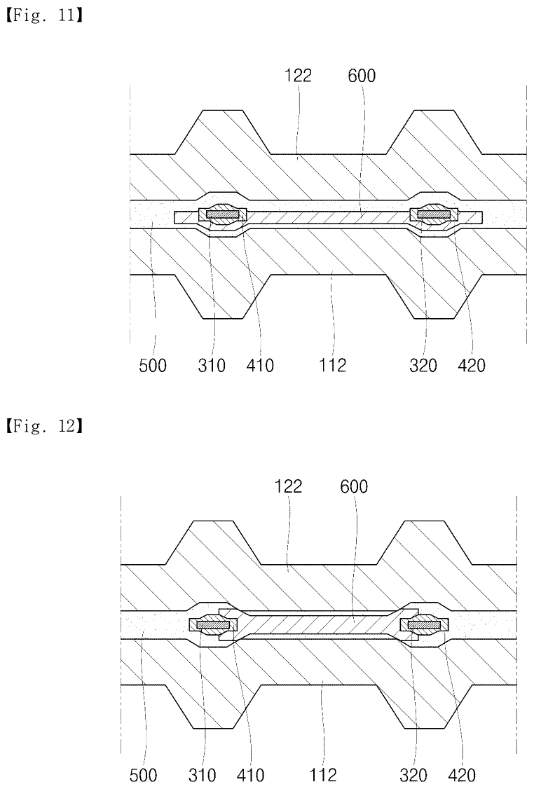

Referring to FIGS. 11 and 12, the conductive layer 600 may be disposed in a reference (e.g., a set or predetermined) region.

Referring to FIG. 11, the conductive layer 600 may be disposed on or under the insulating layers 410 and 420. For example, the conductive layer 600 may be disposed under the insulating layers 410 and 420. Accordingly, the upper portion of the insulating layers 410 and 420 may be in direct contact with the sealing layer 500.

Because the area at where the insulating layers 410 and 420 and the sealing layer 500 are bonded is increased, the adhesive strength of the case may be improved. Accordingly, when the secondary battery is normally operated, external impurities may be prevented from flowing into the interior of the case.

When the secondary battery is exposed to a high temperature environment, the conductive layer 600 may melt, and the first lead 310 and the second lead 320 may be electrically connected via the conductive layer 600. Accordingly, the secondary battery may be short-circuited and self-discharge, thereby preventing a fire of the secondary battery.

Referring to FIG. 12, the conductive layer 600 may partially surround (e.g., may partially extend around) the insulating layers 410 and 420. For example, the conductive layer 600 may cover about 20% to about 50% of the width of the insulating layers 410 and 420.

Accordingly, the region at where the insulating layers 410 and 420 is exposed may be in direct contact with the sealing layer 500. Because the area at where the insulating layers 410 and 420 and the sealing layer 500 are bonded increases, the adhesive strength of the case may be improved. Accordingly, when the secondary battery operates normally, external impurities may be prevented from flowing into the interior of the case.

When the secondary battery is exposed to a high temperature environment, the conductive layer 600 melts, and the first lead 310 and the second lead 320 may be electrically connected via the conductive layer 600. Accordingly, the secondary battery is short-circuited and self-discharges, thereby preventing a fire of the secondary battery.

When the conductive layer 600 surrounds (or extends around) less than about 20% of the width of the insulating layers 410 and 420, when the insulating layers 410 and 420 melts, the leads 310 and 320 and the conductive layer 600 may not contact each other. Accordingly, the short circuit of the secondary battery may not occur. When the conductive layer 600 surrounds more than about 50% of the width of the insulating layers 410 and 420, the area in which the insulating layers 410 and 420 are exposed may be reduced. Accordingly, compared with an embodiment in which the conductive layer 600 completely (or entirely) surrounds the insulating layers 410 and 420, the adhesive force effect may not be significant.

The secondary battery, according to embodiments of the present disclosure, includes the conductive layer.

The conductive layer is disposed between the insulating layer of the lead and the sealing layer of the case. When the secondary battery is normally operated, the lead is insulated from the sealing layer by the insulating layer.

The melting temperatures of the insulating layer and the sealing layer are different. For example, the melting temperature of the insulating layer is lower than the melting temperature of the sealing layer.

When the secondary battery is exposed to a high temperature environment due to overcharge or malfunction, the insulating layer melts before the sealing layer. As the insulating layer melts, the lead is exposed to the outside. Accordingly, the first lead and the second lead contact the conductive layer. Accordingly, the first lead and the second lead are electrically connected via the conductive layer. Accordingly, the positive and negative electrodes of the electrode assembly are short-circuited. Accordingly, the secondary battery self-discharges. Accordingly, collapse of the positive electrode structure of the secondary battery may be prevented, and thus, fire of the secondary battery due to thermal runaway may be prevented.

The conductive layer may have a reference (e.g., a set or predetermined) resistance. The resistance of the conductive layer may change according to the current of the secondary battery. Therefore, the discharge speed of the secondary battery may increase as the State of Charge of the secondary battery increases. Therefore, the secondary battery may be quickly discharged before a fire occurs in the secondary battery.

The buffer layer may be disposed between the sealing layer and the conductive layer. Accordingly, the adhesive strength of the sealing layer and the conductive layer, which are different materials, may be improved. Accordingly, a gap may be prevented from being formed in the adhesive region of the case.

Therefore, the secondary battery, according to embodiments of the present disclosure, may exhibit improved reliability and safety.

The secondary battery described above may be used to configure a battery module. For example, the battery module may include a plurality of secondary batteries. The plurality of secondary batteries may be connected to each other in series, in parallel, or in series/parallel by a bus bar.

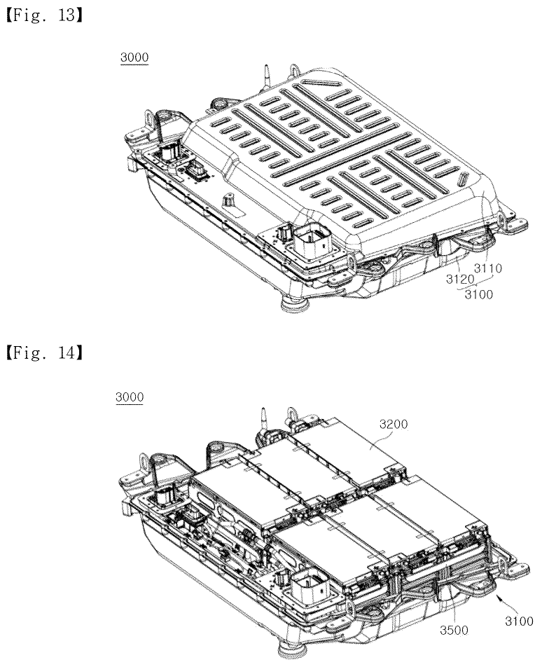

FIGS. 13 and 14 show a battery pack 3000 according to one or more embodiments of the present disclosure. The battery pack 3000 may include a plurality of battery modules 3200 and a housing 3100 for accommodating the plurality of battery modules 3200. For example, the housing 3100 may include first and second housings 3110 and 3120 coupled in opposite directions with the plurality of battery modules 3200 therebetween. The plurality of battery modules 3200 may be electrically connected to each other by using a bus bar, and the plurality of battery modules 3200 may be electrically connected to each other in a series/parallel or series-parallel mixed method, thereby obtaining desired (e.g., required) electrical output. In the drawings, for convenience of illustration, parts such as bus bars, cooling units, and external terminals for electrical connection of secondary battery are omitted. In one or more embodiments, the battery pack 3300 may be mounted in a vehicle. The vehicle may be or may include, for example, an electric vehicle, a hybrid vehicle, or a plug-in hybrid vehicle. A vehicle may include a four-wheeled vehicle or a two-wheeled vehicle.

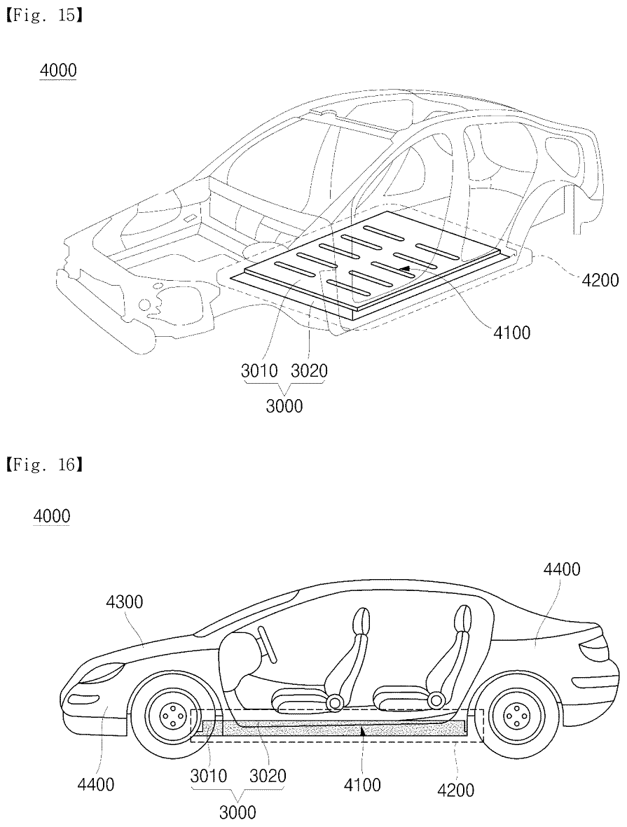

In FIG. 15, a battery pack 3000 may include a battery pack cover 3010, which is a part of a vehicle underbody 4100 and may correspond to the first housing, and a pack frame 3020, which is disposed under the vehicle underbody 4100 and may corresponding to the second housing. The battery pack cover 3010 and the pack frame 3020 may be, for example, integrally formed with a vehicle floor 4200. The vehicle underbody 4100 separates the inside and outside of a vehicle, and the pack frame 3020 may be disposed outside the vehicle

In FIG. 16, a vehicle 4000 may be formed by combining additional parts, such as a hood 4300 in front of the vehicle 4000 and fenders 4400 respectively located in the front and rear of the vehicle 4000 to a vehicle body part. The vehicle 4000 may include the battery pack 3000 including the battery pack cover 3010 and the pack frame 3020, and the battery pack 3000 may be coupled to the vehicle body part.

Only some embodiments are described herein for implementing a secondary battery according to the present disclosure, the present disclosure is not limited to the above-described embodiments, and various modifications can be made by anyone having ordinary skill in the art to which the present disclosure pertains without departing from the gist of the present disclosure as claimed in the following claims and their equivalents.

What is claimed is:

1. A secondary battery comprising:
a case; and
an electrode assembly accommodated in the case, the electrode assembly comprising a first electrode, a second electrode, and a separator,
wherein the first electrode and the second electrode comprise electrode tabs,
wherein the electrode tabs of the first electrode and the second electrode are respectively connected to leads,
wherein an insulating layer is on one region of the leads,
wherein a sealing layer is on a sealing region of the case, and
wherein a conductive layer is arranged between the insulating layer and the sealing layer.

2. The secondary battery as claimed in claim 1, wherein the first electrode comprises a first electrode tab connected to a first lead of the leads,
wherein the second electrode comprises a second electrode tab connected to a second lead of the leads,
wherein a first insulating layer of the insulating layer is on the first lead, and
wherein a second insulating layer of the insulating layer is on the second lead.

3. The secondary battery as claimed in claim 1, wherein a melting temperature of the insulating layer and the sealing layer are different from each other.

4. The secondary battery as claimed in claim 3, wherein the melting temperature of the insulating layer is lower than the melting temperature of the sealing layer.

5. The secondary battery as claimed in claim 4, wherein a difference in melting temperature between the insulating layer and the sealing layer is in a range of 30° C. to 50° C.

6. The secondary battery as claimed in claim 4, wherein the melting temperature of the insulating layer is in a range of 90° C. to 110° C., and
wherein the melting temperature of the sealing layer is in a range of 130° C. to 140° C.

7. The secondary battery as claimed in claim 1, wherein a resistance of the conductive layer is in a range of 100 mΩ to 1Ω.

8. The secondary battery as claimed in claim 1, wherein the case has a first edge and a second edge,
wherein the leads are on the first edge,
wherein the second edge extends from an end of the first edge,
wherein the first edge and the second edge form a sealing region,
wherein the insulating layer, the sealing layer, and the conductive layer are on the sealing region at the first edge, and
wherein the sealing layer is on the sealing region at the second edge.

9. The secondary battery as claimed in claim 8, wherein the first edge has a first region at where the insulating layer is arranged and a second region at where the insulating layer is not present, and
wherein the conductive layer is at the first region.

10. The secondary battery as claimed in claim 9, wherein a thickness of the conductive layer at the first region is defined as A, and a sum of thicknesses of the conductive layer at the first region and the insulating layer at the first region is defined as B,
wherein the thickness of the conductive layer at the first region satisfies the following equation:
$$B * 0.2 \leq A \leq B * 0.5 .$$

11. The secondary battery as claimed in claim 1, wherein the conductive layer is on at least one of upper and lower portions of the insulating layer.

12. The secondary battery as claimed in claim 1, wherein the conductive layer partially surrounds the insulating layer.

13. A secondary battery comprising:
a case; and
an electrode assembly accommodated in the case, the electrode assembly comprising a first electrode, a second electrode, and a separator,
wherein the first electrode and the second electrode each comprises an electrode tab,
wherein the electrode tab of the first electrode and the electrode tab of the second electrode are respectively connected to leads,
wherein an insulating layer is on one region of each of the leads,
wherein a sealing layer is on a sealing region of the case,
wherein a conductive layer is between the insulating layer and the sealing layer, and
wherein, when an internal temperature of the electrode assembly increases to 100° C. or higher, the insulating layer melts before the sealing layer melts.

14. The secondary battery as claimed in claim 13, wherein the electrode tab of the first electrode is a first electrode tab,
wherein the electrode tab of the second electrode is a second electrode tab,
wherein the first electrode tab is connected to a first lead,
wherein the second electrode tab is connected to a second lead,
wherein a first insulating layer of the insulating layer is on the first lead,
wherein a second insulating layer of the insulating layer is on the second lead, and
wherein, when the first insulating layer and the second insulating layer melt, the first lead and the second lead are electrically connected to each other via the conductive layer.

15. The secondary battery as claimed in claim 13, wherein a difference in melting temperature between the insulating layer and the sealing layer is in a range of 30° C. to 50° C.

16. The secondary battery as claimed in claim 13, wherein a resistance of the conductive layer is in a range of 100 mΩ to 1Ω, and,
wherein the resistance of the conductive layer varies depending on a current of the secondary battery.

17. The secondary battery as claimed in claim 16, wherein the resistance of the conductive layer is inversely proportional to the current of the secondary battery.
